(19) United States
(12) Patent Application Publication
(10) Pub. No.: US 2021/0063239 A1
(43) Pub. Date: Mar. 4, 2021

(54) METHOD AND SYSTEM FOR CALIBRATING LASER POWER

(71) Applicant: PRIMAX ELECTRONICS LTD., Taipei City (TW)

(72) Inventors: SHIH-CHIEH HSU, Taipei City (TW); WEI-LUNG HUANG, Taipei City (TW); PEI-MING CHANG, Taipei City (TW); PAO-CHUNG CHAO, Taipei City (TW); WEN-CHIH SHEN, Taipei City (TW)

(21) Appl. No.: 16/660,413

(22) Filed: Oct. 22, 2019

(30) Foreign Application Priority Data
Aug. 30, 2019 (TW) 108131380

(51) Int. Cl. G01J 1/18; G06F 17/50; G01J 1/04; G01J 1/42; H01S 3/10; H01S 3/13

(52) U.S. Cl. CPC G01J 1/18; G06F 17/5009; G01J 1/04; G06F 2217/16; H01S 3/10069; H01S 3/1305; G01J 1/4257

(57) ABSTRACT

Disclosures of the present invention describe a method for calibrating laser power. During a laser power calibration of a laser optics product, reference intensity data and reference power data are adopted for generating a reference trend line with a R² value that is equal to 1. As such, real intensity data that have a residual value smaller than a threshold value are adopted for generating a first trend line in combination with real power data. Moreover, the real intensity data that have a residual value greater than the threshold value are utilized for generating a second trend line in combination with corresponding real power data. Consequently, under an assistance of a predict trend line constituted by the first trend line and the second trend line, the laser power calibration is therefore completed after the laser optics product successively emits a laser beam by a few times.

### FIELD OF THE INVENTION

The present invention relates to the technology field of laser power detecting and calibrating, and in particular, to a method and system for calibrating laser power.

### BACKGROUND OF THE INVENTION

It is well known that laser is a specific light source that is different from normal visible light source. As explained more in detail below, normal visible lights are all a kind of spontaneous emission light source. However, the word “laser” is an acronym standing for Light Amplification by Stimulated Emission of Radiation. A laser beam is created from a substance known as an active medium, which when stimulated by light or electricity produces photons of a specific wavelength. Nowadays, laser optics has been widely applied in various fields, including industrial manufacture, biomedical technology, electronic entertainment devices, and so forth. It needs to know that, there are relevant regulations made for various laser products because high-power laser light is found to cause damage of human's eyes. For example, the power of a laser pointer is limited in a range from 1 mW to 5 mW, the power of a laser pick-up head of a DVD player is bound in a range between 5 mW and 10 mW, and the power of a high-power laser pointer is confined in 1 W. Accordingly, all kinds of laser optics product are required to receive a power detection and calibration, in order to make sure that each of the laser optics product can work normally, and meets relevant regulations thereof.

U.S. patent publication No. 2018/0183208A1 discloses a system for calibrating, operating, and setting a laser diode. According to the disclosures of the forgoing U.S. patent, the system mainly comprises a laser power meter and a back-end controlling and processing device like an industrial computer. When executing a laser power calibration of a laser optics product, the controlling and processing device firstly drives a laser optics product to emit a laser light (beam) that has a maximum power, such as 511 mW. Subsequently, after the laser power meter completes a real power measurement of the forgoing laser light, the controlling and processing device is able to determine whether the maximum power of the laser light that is emitted by the laser optics product is fall in a standard value range or not. As explained more in detail below, in case of the measured maximum power of the laser light and a reference maximum power having a difference ratio that is less than ±1%, the laser optics product passes the laser power calibration.

On the contrary, when the real maximum power of the laser light is measured to exceed an upper spec of the standard value range, the controlling and processing device would subsequently drive the laser optics product to emit a laser light that has a minimum power, wherein the minimum power is commonly 0 mW. Therefore, after the laser power meter completes a real power measurement of the forgoing laser light, the controlling and processing device is able to calculate a difference value between the minimum power of the laser light and a reference minimum power (i.e., 0 mW), thereby deciding a steppedly-increasing value of the intensity of the laser light that is emitted from the laser optics product. For the conventional laser diode calibrating system, it repeatedly executes the above-introduced steps for constantly adjusting the intensity of a laser light that is emitted from a specific laser optics product until a difference value between the measured maximum power of the laser light and a reference maximum power is fall in a standard value range.

From above descriptions, it is understood that the conventional laser optics product calibrating system fails to achieve a laser power calibration of a specific laser optics product effectively and rapidly. In view of that, inventors of the present application have made great efforts to make inventive research and eventually provided a method and system for calibrating laser power.

### SUMMARY OF THE INVENTION

A primary objective of the present invention is to provide present invention discloses a method for calibrating laser power. During a laser power calibration of a laser optics product, a plurality of reference intensity data and a plurality of reference power data are adopted for generating a reference trend line with a R² value that is equal to 1. Subsequently, the reference trend line is adopted for applying a residual value calculation to each of a plurality of real intensity data. After that, the real intensity data that have a residual value smaller than a threshold value are adopted for generating a first trend line in combination with a plurality of real power data thereof. Moreover, the real intensity data that have a residual value greater than the forgoing threshold value are also utilized for generating a second trend line in combination with their corresponding real power data. Consequently, under an assistance of a predict trend line that is constituted by the first trend line and the second trend line, the laser power calibrating system is able to complete the laser power calibration after the laser optics product successively emits a laser beam by a few times.

To achieve the foregoing objective, the present invention provides one embodiment for the method for calibrating laser power, comprising following steps:

(1) letting a laser optics product successively emits a laser light by a plurality of times, so as to receive the laser light by using a light receiving unit;

(2) configuring a controlling and processing device to record a plurality of real intensity data and a plurality of real power data in a data storage unit thereof, wherein the respective real intensity data and real power data are measured from the respective laser lights that are emitted by the laser optics product in the respective times;

(3) configuring the controlling and processing device to generate a reference trend line based on a plurality of reference intensity data and a plurality of reference power data, wherein the reference trend line has a coefficient of determination that is equal to 1;

(4) configuring the controlling and processing device to apply a first linear regression process to the plurality of real intensity data and the plurality of real power data for producing a first linear regression graph, thereby adding the reference trend line in the first linear regression graph;

(5) configuring the controlling and processing device to select a plurality of first intensity data and a plurality of first power data from the first linear regression graph, and subsequently apply a second linear regression process to the plurality of first intensity data and the plurality of first power data for producing a second linear regression graph with a first trend line; wherein each of the selected first intensity data has a first residual value smaller than a threshold value, and the respective first intensity data being determined by correspondingly comparing the respective reference intensity data with the reference trend line as well as that the residual value being smaller than the threshold value;

(6) configuring the controlling and processing device to select a plurality of second intensity data and a plurality of second power data from the first linear regression graph, and subsequently apply a third linear regression process to the plurality of second intensity data and the plurality of second power data for producing a third linear regression graph; wherein each of the selected second intensity data has a second residual value greater than the threshold value, and the respective first intensity data being determined by correspondingly comparing the respective reference intensity data with the reference trend line as well as that the residual value being greater than the threshold value; and

(7) configuring the controlling and processing device to produce a fourth linear regression graph using the plurality of real intensity data, the plurality of real power data, the first trend line, and the second trend line, wherein the fourth linear regression graph has a predict trend line that is constituted by the first trend line and the second trend line.

In the embodiment of the forgoing method for calibrating laser power, the controlling and processing device comprises:

a controlling and processing unit, being coupled to the data storage unit;

a reference trend line generating unit, being coupled to the data storage unit and the controlling and processing unit, and being configured for executing the step (3);

a first trend line generating unit, being coupled to the reference trend line generating unit, and being configured for executing the step (4);

a second trend line generating unit, being coupled to the first trend line generating unit, and being configured for executing the step (5);

a third trend line generating unit, being coupled to the first trend line generating unit, and being configured for executing the step (6); and

a trend lines integrating unit, being coupled to the third trend line generating unit, the second trend line generating unit and the data storage unit, and being configured for executing the step (7).

In the embodiment of the forgoing method for calibrating laser power, the controlling and processing device is an electronic device that is selected from the group consisting of handheld laser power meter, desk laser power meter, industrial computer, desk computer, laptop computer, tablet computer, and smart phone.

In the embodiment of the forgoing method for calibrating laser power, a laser power calculating unit is provided in the light receiving unit or the controlling and processing device.

In the embodiment of the forgoing method for calibrating laser power, the reference trend line generating unit, the first trend line generating unit, the second trend line generating unit, the third trend line generating unit, and the trend lines integrating unit are all edited to an application program through libraries, variables, or operands, so as to be provided in the controlling and processing device.

In the embodiment of the forgoing method for calibrating laser power, the controlling and processing device further comprises a display unit, a human machine interface (HMI) unit and a data transmission unit.

In the embodiment of the forgoing method for calibrating laser power, the data storage unit is selected from the group consisting of memory chip, memory card and external storage device.

In the embodiment of the forgoing method for calibrating laser power, the data transmission unit is a wired transmission interface or a wireless transmission interface.

In the embodiment of the forgoing method for calibrating laser power, the light receiving unit is further provided with a detachable optical filter, such that the laser light is applied with an optically-filtering process by the detachable optical filter before being received by the light receiving unit.

Moreover, for achieving the foregoing objective, the present invention provides one embodiment of a system for calibrating laser power, comprising:

a light receiving unit, being adopted for receiving a laser light that is emitted from a laser optic product; and

a controlling and processing device, comprising:

a controlling and processing unit, being electrically connected to the light receiving unit, and being configured for driving the laser optics product to successively emits the laser light by a plurality of times, so as to receive the laser light through the light receiving unit;

a data storage unit, being coupled to the controlling and processing unit, such that the controlling and processing device records a plurality of real intensity data and a plurality of real power data in the data storage unit; wherein the respective real intensity data and real power data are measured from the respective laser lights that are emitted by the laser optics product in the respective times;

a reference trend line generating unit, being coupled to the data storage unit and the controlling and processing unit, and being configured for generating a reference trend line based on a plurality of reference intensity data and a plurality of reference power data; wherein the reference trend line has a coefficient of determination that is equal to 1;

a first trend line generating unit, being coupled to the reference trend line generating unit, and being configured for applying a first linear regression process to the plurality of real intensity data and the plurality of real power data so as to produce a first linear regression graph, thereby adding the reference trend line in the first linear regression graph;

a second trend line generating unit, being coupled to the first trend line generating unit, and being configured to select a plurality of first intensity data and a plurality of first power data from the first linear regression graph, and then to apply a second linear regression process to the plurality of first intensity data and the plurality of first power data for producing a second linear regression graph with a first trend line; wherein each of the selected first intensity data has a first residual value smaller than a threshold value, and the respective first residual value being determined by correspondingly comparing the respective reference intensity data with the respective reference intensity data;

a third trend line generating unit, being coupled to the first line generating unit, and being configured to select a plurality of second intensity data and a plurality of second power data from the first linear regression graph, and subsequently apply a third linear regression process to the plurality of second intensity data and the plurality of second power data for producing a third linear regression graph; wherein each of the selected second intensity data has a second residual value greater than the threshold value, and the respective second residual value being determined by correspondingly comparing the respective reference intensity data with the respective reference intensity data; and

a trend lines integrating unit, being coupled to the third trend line generating unit, the second trend line generating unit and the data storage unit, and being configured to produce a fourth linear regression graph using the plurality of real intensity data, the plurality of real power data, the first trend line, and the second trend line; wherein the fourth linear regression graph has a predict trend line that is constituted by the first trend line and the second trend line.

In the embodiment of the forgoing system for calibrating laser power, the controlling and processing device is an electronic device that is selected from the group consisting of handheld laser power meter, desk laser power meter, industrial computer, desk computer, laptop computer, tablet computer, and smart phone.

In the embodiment of the forgoing system for calibrating laser power, a laser power calculating unit is provided in the light receiving unit or the controlling and processing device.

In the embodiment of the forgoing system for calibrating laser power, the reference trend line generating unit, the first trend line generating unit, the second trend line generating unit, the third trend line generating unit, and the trend lines integrating unit are all edited to an application program through libraries, variables, or operands, so as to be provided in the controlling and processing device.

In the embodiment of the forgoing system for calibrating laser power, the controlling and processing device further comprises a display unit, a human machine interface (HMI) unit and a data transmission unit.

In the embodiment of the forgoing system for calibrating laser power, the data storage unit is selected from the group consisting of memory chip, memory card and external storage device.

In the embodiment of the forgoing system for calibrating laser power, the data transmission unit is a wired transmission interface or a wireless transmission interface.

In the embodiment of the forgoing system for calibrating laser power, the light receiving unit is further provided with a detachable optical filter, such that the laser light is applied with an optically-filtering process by the detachable optical filter before being received by the light receiving unit.

### BRIEF DESCRIPTION OF THE DRAWINGS

FIG. 1 shows one stereo diagram of a system for calibrating laser power according to the present invention.

FIG. 2A shows a flowchart diagram of a method for calibrating laser power according to the present invention.

FIG. 2B shows a flowchart diagram of the method for calibrating laser power according to the present invention.

FIG. 3 shows a data scatter plot of laser power versus laser intensity provided with a reference linear regression graph therein.

FIG. 4 shows a data scatter plot of laser power versus laser intensity provided with a first linear regression graph therein.

FIG. 5 shows a data scatter plot of laser power versus laser intensity provided with a second linear regression graph therein.

FIG. 6 shows a data scatter plot of laser power versus laser intensity provided with a third linear regression graph therein.

FIG. 7 shows a data scatter plot of laser power versus laser intensity provided with a fourth linear regression graph therein.

FIG. 8 shows a function block diagram of a controlling and processing device.

FIG. 9 shows another one stereo diagram of the system for calibrating laser power according to the present invention.

### DETAILED DESCRIPTION OF THE PREFERRED EMBODIMENT

The advantages and features of a method and system for calibrating laser power according to the present invention are described in details with reference to examples of embodiments and accompanying drawings to be more easily understood. However, the present invention may be implemented in different forms, and should not be construed as limited to only embodiments described herein. Conversely, for a person skilled in the art, the embodiments are provided for making the disclosure more thorough and comprehensive and completely conveying the scope of the present invention.

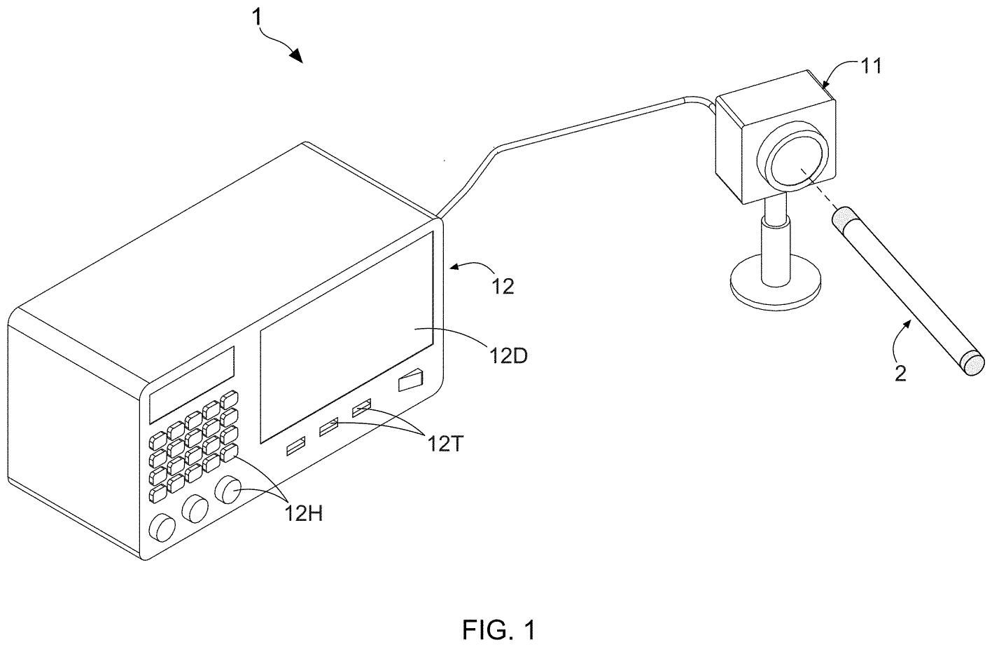

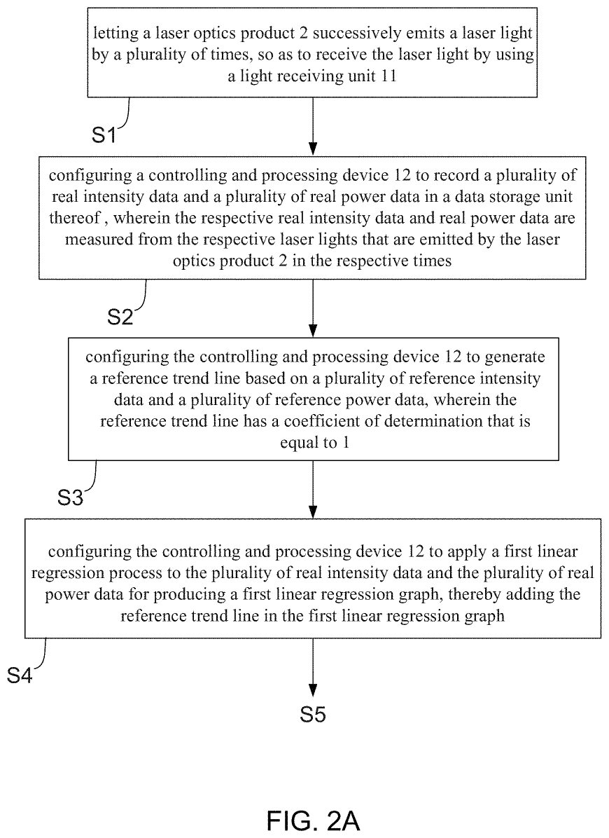

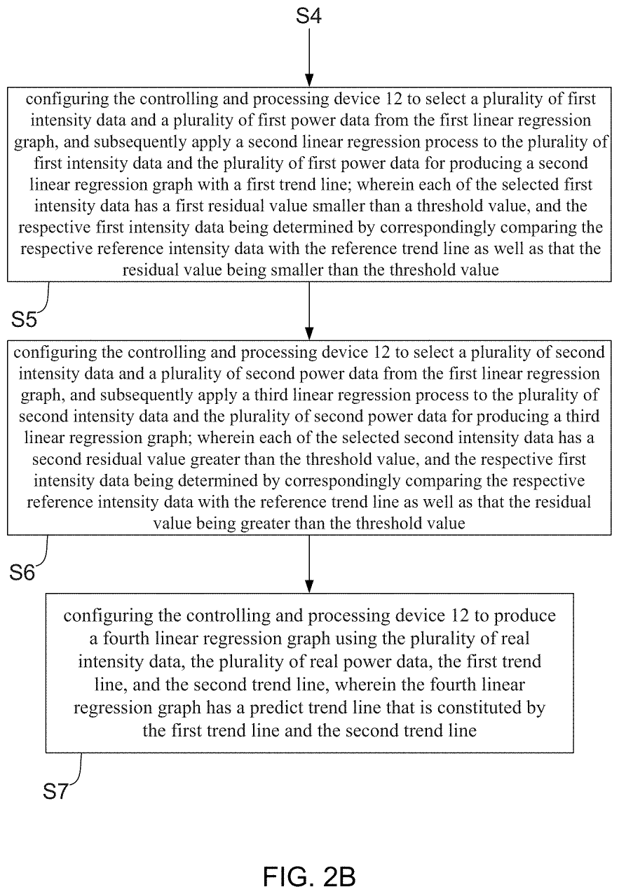

With reference to FIG. 1, there is provided one stereo diagram of a system for calibrating laser power according to the present invention. Moreover, flowchart diagrams of a method for calibrating laser power according to the present invention are depicted in FIG. 2A and FIG. 2B. The laser power calibrating method of the present invention is mainly applied in a controlling and processing device 12. For example, FIG. 1 exemplarily depicts that the controlling and processing device 12 is a desk laser power meter. As explained more in detail below, the laser power calibrating method of the present invention is particularly configured for enhancing a power calibration efficiency of the laser power meter when the laser power meter applies a power detection and calibration to a specific laser optics product 2. As FIG. 2A shows, the method flow is firstly proceeded to step S1 for letting a laser optics product 2 successively emits a laser light by a plurality of times, so as to receive the laser light by using a light receiving unit 11. In step S2, a controlling and processing device 12 is configured to record a plurality of real intensity data and a plurality of real power data in a data storage unit thereof, wherein the respective real intensity data and real power data are measured from the respective laser lights that are emitted by the laser optics product 2 in the respective times. For example, the data storage unit of the controlling and processing device 12 would store with 3,000 records of the real intensity data and 3,000 records of the real power data after the laser optics product 2 successively emits a laser light by 3,000 times.

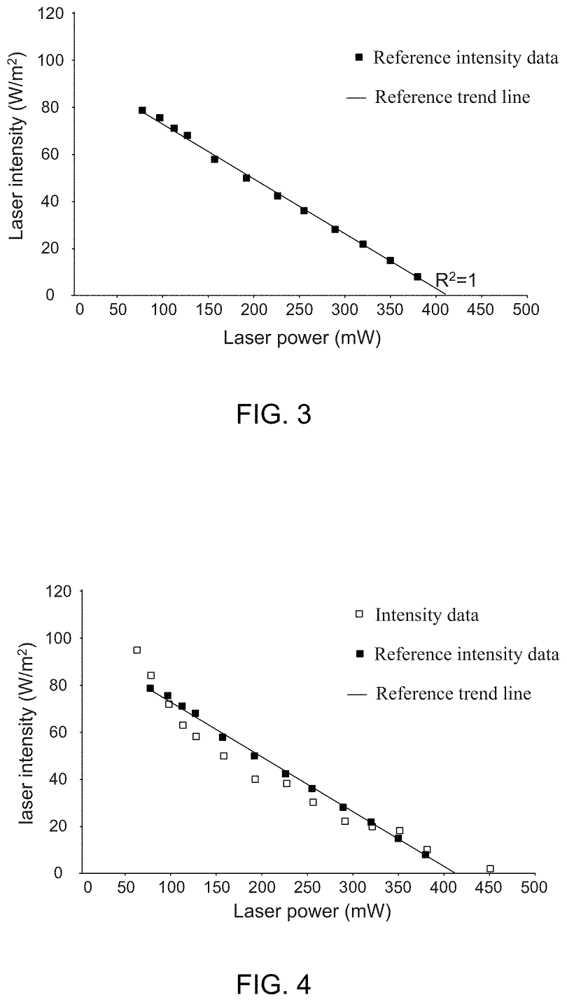

Subsequently, the method flow is proceeded to step S3 for configuring the controlling and processing device 12 to generate a reference trend line based on a plurality of reference intensity data and a plurality of reference power data, wherein the reference trend line has a coefficient of determination that is equal to 1. FIG. 3 shows a data scatter plot of laser power versus laser intensity provided with a reference linear regression graph therein. From FIG. 3, it is understood that, the forgoing reference trend line is generated by applying a linear regression process to the plurality of reference intensity data and the plurality of reference power data. Moreover, the reference trend line has a coefficient of determination (i.e., R²) that is equal to 1.

After the step S3 is completed, the method flow is next proceeded to step S4, such that the controlling and processing device 12 is configured to apply a first linear regression process to the plurality of real intensity data and the plurality of real power data for producing a first linear regression graph, thereby adding the reference trend line in the first linear regression graph. FIG. 3 shows a data scatter plot of laser power versus laser intensity provided with a first linear regression graph therein. It is worth noting that, the forgoing reference trend line is also provided in the first linear regression graph of FIG. 4, wherein the reference trend line has a coefficient of determination (i.e., R²) that is equal to 1.

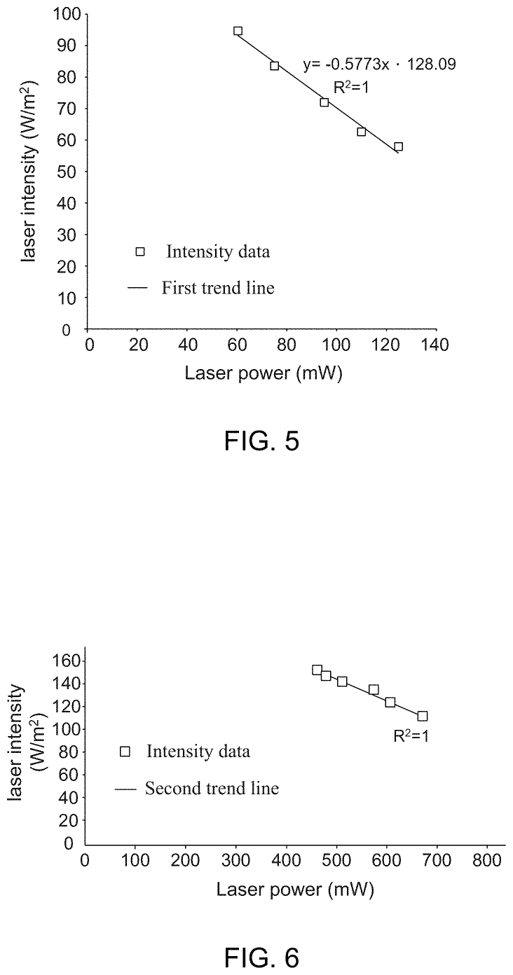

As FIG. 1 and FIG. 2B show, the method flow is subsequently proceeded to step S5, such that the controlling and processing device 12 is configured to select a plurality of first intensity data and a plurality of first power data from the first linear regression graph (as shown in FIG. 4), and then to apply a second linear regression process to the plurality of first intensity data and the plurality of first power data for producing a second linear regression graph with a first trend line. Herein, it needs to particularly explain that, each of the selected first intensity data has a first residual value smaller than a threshold value, and the respective first intensity data are determined by correspondingly comparing the respective reference intensity data with the reference trend line as well as make sure that the residual value is smaller than the threshold value. The forgoing threshold value can be exemplarily 8. FIG. 5 shows a data scatter plot of laser power versus laser intensity provided with a second linear regression graph therein. Briefly speaking, the real intensity data that has residual value smaller than 8 is chosen for being as the first intensity data. Similarly, the real power data that has residual value smaller than 8 is chosen for being as the first power data. As a result, the second linear regression graph with the first trend line is generated by applying a linear regression process to the selected first power data and first intensity data. It is worth noting that, the first trend line provided in the second linear regression graph of FIG. 5 also has a coefficient of determination (i.e., R²) that is equal to 1.

Herein, it needs to particularly explain that, the forgoing threshold value should be properly adjusted or changed according to different kinds of the laser optics product 2. In other words, although above descriptions have introduced that the threshold value can be exemplarily 8, it is not meant that the threshold value is a constant of 8. Continuously, the method flow is next proceeded to step S6. In step S6, the controlling and processing device 12 is configured to select a plurality of second intensity data and a plurality of second power data from the first linear regression graph, and then to apply a third linear regression process to the plurality of second intensity data and the plurality of second power data for producing a third linear regression graph. Herein, it needs to particularly explain that, each of the selected second intensity data has a second residual value greater than the threshold value, and the respective second intensity data are determined by correspondingly comparing the respective reference intensity data with the reference trend line as well as make sure that the residual value is greater than the threshold value. The forgoing threshold value is also exemplarily 8. FIG. 6 shows a data scatter plot of laser power versus laser intensity provided with a third linear regression graph therein. Briefly speaking, the real intensity data that has residual value greater than 8 is chosen for being as the second intensity data. Similarly, the real power data that has residual value greater than 8 is chosen for being as the second power data. As a result, the third linear regression graph with the second trend line is generated by applying a linear regression process to the selected second power data and second intensity data. It is worth noting that, the second trend line provided in the third linear regression graph of FIG. 6 also has a coefficient of determination (i.e., R²) that is equal to 1.

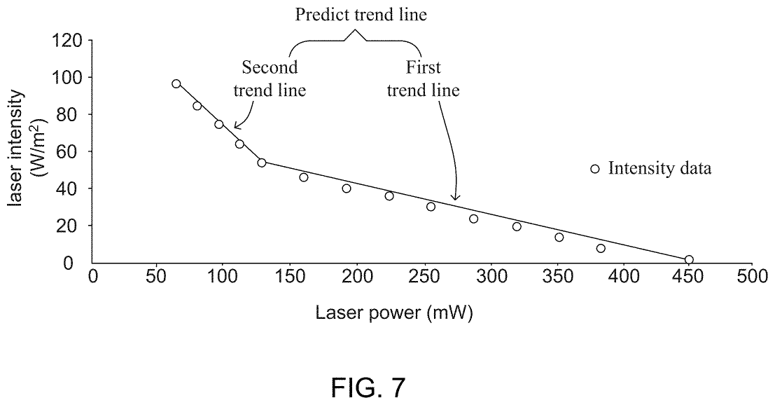

Consequently, FIG. 1 and FIG. 2B depict that the method flow is eventually proceeded to step S7, such that the controlling and processing device 12 is configured for producing a fourth linear regression graph using the plurality of real intensity data, the plurality of real power data, the first trend line, and the second trend line. FIG. 7 shows a data scatter plot of laser power versus laser intensity provided with a fourth linear regression graph therein. From FIG. 7, it is found that the fourth linear regression graph has a predict trend line that is constituted by the first trend line and the second trend line. It should simultaneously understand that, the forgoing first trend line is obtained after completing the step S5, and the forgoing second trend line is produced by achieving the step S6. As a result, when the laser power meter (i.e., the controlling and processing device 12) applies a power detection and calibration to a specific laser optics product 2, the predict trend line is helpful in facilitating the laser power meter achieve the laser power calibration of the specific laser optics product 2 effectively, rapidly, and precisely.

Moreover, inventors of the present invention have adopted this laser power calibrating method to apply a power detection and calibration to various laser optics products, and then have obtained experimental data that are recorded in following Table (1). Experimental data of Table (1) have reported that, there are 32.9% of laser optics products having completed their power calibration in the case of just being driven to emit laser light by only one time. Moreover, 54.3% of laser optics products have achieved their power calibration in the condition of being driven to have a laser light emission by two times. On the other hand, there are 11.8% of laser optics products having completed their power calibration in the case of being driven to emit laser light by three times, and 0.9% of laser optics products have achieved their power calibration in the condition of being driven to emit laser light by four times. In addition, it is worth noting that, there are only 0.9% of laser optics products having completed their power calibration in the case of being driven to emit laser light by five times.

TABLE 1

| Percentage (%) | Times of emission of laser light |
|---|---|
| 32.9 | 1 |
| 54.3 | 2 |
| 11.8 | 3 |
| 0.9 | 4 |
| 0.1 | 5 |

In conclusion, after applying this novel laser power calibrating method to a laser power meter (i.e., the controlling and processing device 12), the laser power meter just needs spending 6.46 seconds completing a laser power calibration of a specific laser optics product. On the contrary, the conventional laser power calibrating system takes 14.59 seconds to achieve the laser power calibration of the same laser optics product.

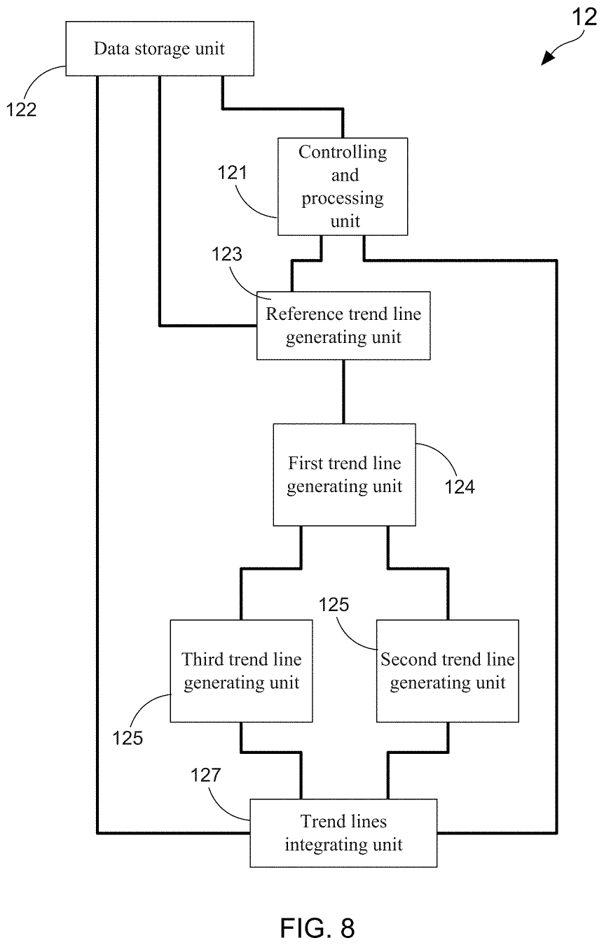

Therefore, above descriptions have introduced the method for calibrating laser power that is proposed by the present invention clearly and completely. In following paragraphs, a system for calibrating laser power of the present invention will be described. FIG. 1 has depicts the laser power calibrating system 1 of the present invention, which mainly comprises a light receiving unit 11 and a controlling and processing device 12. In which, the light receiving unit 11 is adopted for receiving a laser light that is emitted from a laser optic product 2. Moreover, FIG. 8 shows a function block diagram of the controlling and processing device 12. As FIG. 1 and FIG. 8 show, there is a controlling and processing unit 121 provided in the controlling and processing device 12, which is electrically connected to the light receiving unit 11, and is configured for driving the laser optics product 2 to successively emits the laser light by a plurality of times, so as to receive the laser light through the light receiving unit 11. In one practicable embodiment, a laser power calculating unit can be provided in the light receiving unit 11. As such, after the light receiving unit 11 receives the respective laser lights in the respective times, the controlling and processing unit 121 can obtain a plurality of real intensity data and a plurality of real power data from the laser power calculating unit that is provided in the light receiving unit 11. However, in another one practicable embodiment, the forgoing laser power calculating unit can also be provided in the controlling and processing device 12.

FIG. 8 also depicts that the controlling and processing device 12 further comprises: a data storage unit 122, a reference trend line generating unit 123, a first trend line generating unit 124, a second trend line generating unit 125, a third trend line generating unit 126, and a trend lines integrating unit 127. The data storage unit 122 is coupled to the controlling and processing unit 121, such that the controlling and processing unit 121 records the plurality of real intensity data and the plurality of real power data in the data storage unit 122. Herein, it needs particularly explain that, the respective real intensity data and real power data are measured from the respective laser lights that are emitted by the laser optics product 2 in the respective times. On the other hand, the reference trend line generating unit 123 is coupled to the data storage unit 122 and the controlling and processing unit 121, and is configured for executing the step S3 of the FIG. 2A. As described more in detail below, the reference trend line generating unit 123 is adopted for generating a reference trend line based on a plurality of reference intensity data and a plurality of reference power data. As FIG. 3 shows, the forgoing reference trend line has a coefficient of determination (i.e., R²) that is equal to 1.

FIG. 1 and FIG. 8 also depict that, the first trend line generating unit 124 is coupled to the reference trend line generating unit 123, and is configured for executing the step S4 of the FIG. 2A. As explained more in detail below, particularly, the first trend line generating unit 124 is configured for applying a first linear regression process to the plurality of real intensity data and the plurality of real power data so as to produce a first linear regression graph (as shown in FIG. 4), thereby adding the reference trend line in the first linear regression graph. In addition, the second trend line generating unit 125, is coupled to the first trend line generating unit 124, and is configured to execute the step S5 of FIG. 2B. In the present invention, the second trend line generating unit 125 is used for selecting a plurality of first intensity data and a plurality of first power data from the first linear regression graph, and then applying a second linear regression process to the plurality of first intensity data and the plurality of first power data for producing a second linear regression graph with a first trend line. FIG. 5 has depicts the second linear regression graph. Moreover, each of the selected first intensity data has a first residual value smaller than a threshold value, and the respective first residual value are determined by correspondingly comparing the respective reference intensity data with the respective reference intensity data.

From FIG. 1 and FIG. 8, it is known that the third trend line generating unit 126 is coupled to the first generating unit 124, and is configured to execute the step S6 of FIG. 2B. As described more in detail below, the third trend line generating unit 126 is utilized for selecting a plurality of second intensity data and a plurality of second power data from the first linear regression graph, so as to subsequently apply a third linear regression process to the plurality of second intensity data and the plurality of second power data for producing a third linear regression graph. FIG. 6 has depicts the third linear regression graph. It needs to further explain that, each of the selected second intensity data has a second residual value greater than the threshold value (such as 8), and the respective second residual value are determined by correspondingly comparing the respective reference intensity data with the respective reference intensity data.

On the other hand, the trend lines integrating unit 127 is coupled to the third trend line generating unit 126, the second trend line generating unit 125 and the data storage unit 122, and is configured for executing the step S7 of FIG. 2B. As FIG. 7 show, the trend lines integrating unit 127 is adopted to produce a fourth linear regression graph using the plurality of real intensity data, the plurality of real power data, the first trend line, and the second trend line. It is worth noting that, the fourth linear regression graph has a predict trend line that is constituted by the first trend line and the second trend line.

In one practicable embodiment, the reference trend line generating unit 123, the first trend line generating unit 124, the second trend line generating unit 125, the third trend line generating unit 126, and the trend lines integrating unit 127 can be edited to an application program through libraries, variables, or operands, so as to be provided in the controlling and processing device 12. Therefore, it should know that the said controlling and processing device 12 that is illustrated in in FIG. 1 is not limited to a desk laser power meter, but can also be a handheld laser power meter, an industrial computer, a desk computer, a laptop computer, a tablet computer, or a smart phone. In other words, the controlling and processing device 12 can be presented by a form of electronic device, such that the controlling and processing device 12 can easily receive relevant data of laser light from the light receiving unit 11 through a data transmission unit 12T thereof.

In addition, FIG. 1 also depicts that the controlling and processing device 12 further comprises a display unit 12D and a human machine interface (HMI) unit 12H. Functions of the display unit 12D and the HMI unit 12H are already well known, such that there are no relevant introductions and/or descriptions for the display unit 12D and the HMI unit 12H in following paragraphs. On the other hand, the forgoing data storage unit 122 is commonly a memory module that is integrated in the controlling and processing device 12. For instance, the data storage unit 122 is a memory chip or a memory card. In other practicable embodiment, the data storage unit 122 can also be an external storage device.

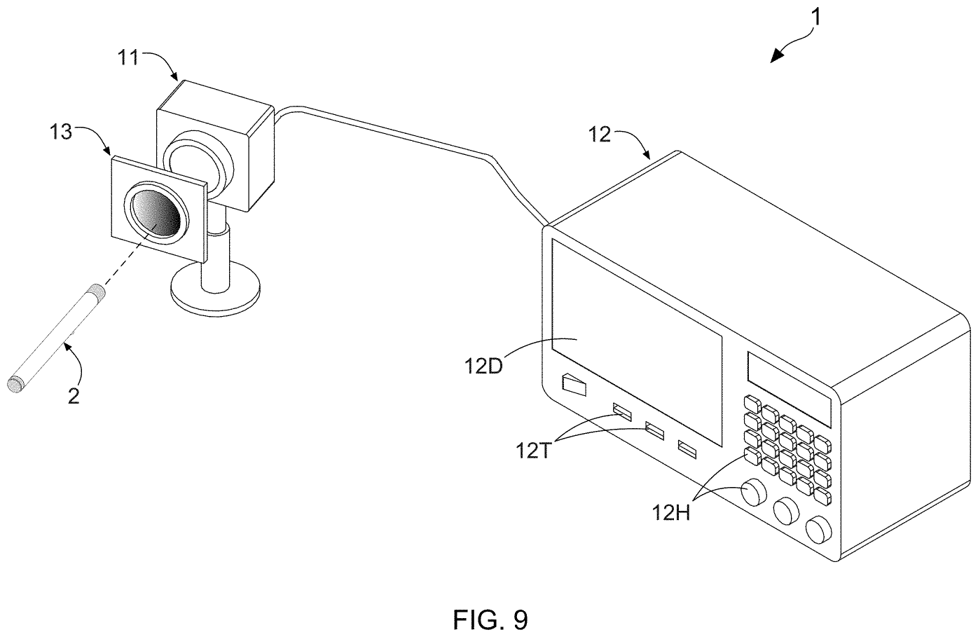

FIG. 9 shows another one stereo diagram of the system for calibrating laser power according to the present invention. In FIG. 9, there is a detachable optical filter 13 provided between the laser light and the light receiving unit 11, such that the laser light is applied with an optically-filtering process by the detachable optical filter 13 before being received by the light receiving unit 11. From example, in case of the lase optics product 2 is a laser pointer capable of emitting a red laser light, the detachable optical filter 13 is adopted for merely allowing the red laser light to pass through, thereby guaranteeing that the light receiving unit 11 purely receive the red laser light. As such, the disposing of the detachable optical filter 13 is helpful in making the controlling and processing device 12 achieve the laser power calibration of the specific laser optics product 2.

Any modification to the present invention made by a person skilled in the art does not depart from the protection scope defined by the appended claims.

What is claimed is:

1. A method for calibrating laser power, comprising following steps:
(1) letting a laser optics product successively emits a laser light by a plurality of times, so as to receive the laser light by using a light receiving unit;
(2) configuring a controlling and processing device to record a plurality of real intensity data and a plurality of real power data in a data storage unit thereof, wherein the respective real intensity data and real power data are measured from the respective laser lights that are emitted by the laser optics product in the respective times;
(3) configuring the controlling and processing device to generate a reference trend line based on a plurality of reference intensity data and a plurality of reference power data, wherein the reference trend line has a coefficient of determination that is equal to 1;
(4) configuring the controlling and processing device to apply a first linear regression process to the plurality of real intensity data and the plurality of real power data for producing a first linear regression graph, thereby adding the reference trend line in the first linear regression graph;
(5) configuring the controlling and processing device to select a plurality of first intensity data and a plurality of first power data from the first linear regression graph, and subsequently to apply a second linear regression process to the plurality of first intensity data and the plurality of first power data for producing a second linear regression graph with a first trend line; wherein each of the selected first intensity data has a first residual value smaller than a threshold value, and the respective first intensity data being determined by correspondingly comparing the respective reference intensity data with the reference trend line as well as that the residual value being smaller than the threshold value;
(6) configuring the controlling and processing device to select a plurality of second intensity data and a plurality of second power data from the first linear regression graph, and subsequently to apply a third linear regression process to the plurality of second intensity data and the plurality of second power data for producing a third linear regression graph; wherein each of the selected second intensity data has a second residual value greater than the threshold value, and the respective second intensity data being determined by correspondingly comparing the respective reference intensity data with the reference trend line as well as that the residual value being greater than the threshold value; and
(7) configuring the controlling and processing device to produce a fourth linear regression graph using the plurality of real intensity data, the plurality of real power data, the first trend line, and the second trend line, wherein the fourth linear regression graph has a predict trend line that is constituted by the first trend line and the second trend line.

2. The method for calibrating laser power according to claim 1, wherein the controlling and processing device comprises:
a controlling and processing unit, being coupled to the data storage unit;
a reference trend line generating unit, being coupled to the data storage unit and the controlling and processing unit, and being configured for executing the step (3);
a first trend line generating unit, being coupled to the reference trend line generating unit, and being configured for executing the step (4);
a second trend line generating unit, being coupled to the first trend line generating unit, and being configured for executing the step (5);
a third trend line generating unit, being coupled to the second trend line generating unit, and being configured for executing the step (6); and
a trend lines integrating unit, being coupled to the third trend line generating unit, the second trend line generating unit and the data storage unit, and being configured for executing the step (7).

3. The method for calibrating laser power according to claim 1, wherein the controlling and processing device is an electronic device that is selected from the group consisting of handheld laser power meter, desk laser power meter, industrial computer, desk computer, laptop computer, tablet computer, and smart phone.

4. The method for calibrating laser power according to claim 1, wherein a laser power calculating unit is provided in the light receiving unit or the controlling and processing device.

5. The method for calibrating laser power according to claim 2, wherein the reference trend line generating unit, the first trend line generating unit, the second trend line generating unit, the third trend line generating unit, and the trend lines integrating unit are all edited to an application program through libraries, variables, or operands, so as to be provided in the controlling and processing device.

6. The method for calibrating laser power according to claim 2, wherein the controlling and processing device further comprises a display unit, a human machine interface (HMI) unit and a data transmission unit.

7. The method for calibrating laser power according to claim 1, wherein the data storage unit is selected from the group consisting of memory chip, memory card and external storage device.

8. The method for calibrating laser power according to claim 6, wherein the data transmission unit is a wired transmission interface or a wireless transmission interface.

9. The method for calibrating laser power according to claim 1, wherein the light receiving unit is further provided with a detachable optical filter, such that the laser light is applied with an optically-filtering process by the detachable optical filter before being received by the light receiving unit.

10. A system for calibrating laser power, comprising:
a light receiving unit, being adopted for receiving a laser light that is emitted from a laser optic product; and
a controlling and processing device, comprising:
a controlling and processing unit, being electrically connected to the light receiving unit, and being configured for driving the laser optics product to successively emits the laser light by a plurality of times, so as to receive the laser light through the light receiving unit;
a data storage unit, being coupled to the controlling and processing unit, such that the controlling and processing unit records a plurality of real intensity data and a plurality of real power data in the data storage unit;
wherein the respective real intensity data and real power data are measured from the respective laser lights that are emitted by the laser optics product in the respective times;
a reference trend line generating unit, being coupled to the data storage unit and the controlling and processing unit, and being configured for generating a reference trend line based on a plurality of reference intensity data and a plurality of reference power data; wherein the reference trend line has a coefficient of determination that is equal to 1;
a first trend line generating unit, being coupled to the reference trend line generating unit, and being configured for applying a first linear regression process to the plurality of real intensity data and the plurality of real power data so as to produce a first linear regression graph, thereby adding the reference trend line in the first linear regression graph;
a second trend line generating unit, being coupled to the first trend line generating unit, and being configured to select a plurality of first intensity data and a plurality of first power data from the first linear regression graph, and then to apply a second linear regression process to the plurality of first intensity data and the plurality of first power data for producing a second linear regression graph with a first trend line; wherein each of the selected first intensity data has a first residual value smaller than a threshold value, and the respective first residual value being determined by correspondingly comparing the respective reference intensity data with the respective reference intensity data;
a third trend line generating unit, being coupled to the first line generating unit, and being configured to select a plurality of second intensity data and a plurality of second power data from the first linear regression graph, and subsequently apply a third linear regression process to the plurality of second intensity data and the plurality of second power data for producing a third linear regression graph; wherein each of the selected second intensity data has a second residual value greater than the threshold value, and the respective second residual value being determined by correspondingly comparing the respective reference intensity data with the respective reference intensity data; and
a trend lines integrating unit, being coupled to the third trend line generating unit, the second trend line generating unit and the data storage unit, and being configured to produce a fourth linear regression graph using the plurality of real intensity data, the plurality of real power data, the first trend line, and the second trend line; wherein the fourth linear regression graph has a predict trend line that is constituted by the first trend line and the second trend line.

11. The system for calibrating laser power according to claim 10, wherein the controlling and processing device is an electronic device that is selected from the group consisting of handheld laser power meter, desk laser power meter, industrial computer, desk computer, laptop computer, tablet computer, and smart phone.

12. The system for calibrating laser power according to claim 10, wherein a laser power calculating unit is provided in the light receiving unit or the controlling and processing device.

13. The system for calibrating laser power according to claim 10, wherein the reference trend line generating unit, the first trend line generating unit, the second trend line generating unit, the third trend line generating unit, and the trend lines integrating unit are all edited to an application program through libraries, variables, or operands, so as to be provided in the controlling and processing device.

14. The system for calibrating laser power according to claim 10, wherein the controlling and processing device further comprises a display unit, a human machine interface (HMI) unit and a data transmission unit.

15. The system for calibrating laser power according to claim 10, wherein the data storage unit is selected from the group consisting of memory chip, memory card and external storage device.

16. The system for calibrating laser power according to claim 14, wherein the data transmission unit is a wired transmission interface or a wireless transmission interface.

17. The method for calibrating laser power according to claim 10, wherein the light receiving unit is further provided with a detachable optical filter, such that the laser light is applied with an optically-filtering process by the detachable optical filter before being received by the light receiving unit.
